(19) United States
(12) Patent Application Publication
(10) Pub. No.: US 2007/0294524 A1
(43) Pub. Date: Dec. 20, 2007

(54) Storage control apparatus, storage control method, and storage apparatus

(75) Inventor: Atsushi Katano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/584,573

(22) Filed: Oct. 23, 2006

(30) Foreign Application Priority Data
Jun. 16, 2006 (JP) 2006-166860

(51) Int. Cl. H04L 9/00

(52) U.S. Cl. 713/151

(57) ABSTRACT

There is provided a storage control apparatus, a storage control method, and a storage apparatus capable of reducing the time required to complete login processing between storage apparatuses connected to each other via a network.

A storage control apparatus comprises: a remote adapter that communicates with the other storage control apparatus connected via a network; and a remote adapter controller that, when receiving an instruction that requires the storage control apparatus to serve as an initiator and the other storage control apparatus to serve as a target, controls the remote adapter to transmit information including an authentication method and encryption algorithm for login to the other storage control apparatus, and controls the remote adapter to transmit encrypted its own authentication information provided by the authentication method using a first encryption key that the remote adapter has received from the other storage control apparatus and a second encryption key to the other storage control apparatus.

### BACKGROUND OF THE INVENTION

1. Field of the Invention

The present invention relates to a storage control apparatus, a storage control method, and a storage apparatus for communication between storage apparatuses connected to each other by a network.

2. Description of the Related Art

In the case where iSCSI (i Small Computer System Interface) is used to copy data between remote machines, an initiator machine needs to login a target machine in order to send an SCSI command to the target machine.

A conventional copy operation performed between remote machines will be described. Firstly, a case where an initiator machine serves as a host and a target machine serves as a RAID (Redundant Arrays of Inexpensive Disks) unit will be described.

Configurations of the conventional host and RAID unit will be described below, respectively. FIG. 3 is a block diagram showing an example of a conventional connection configuration between the host and RAID unit. A host 1 includes a disk controller 1 1, an I/O controller 12, a remote adapter controller 13, a remote adapter 14, and a disk 15. The disk controller 11 controls the operation of the disk 15 and instructs the I/O controller 12 to perform copy operation and the like. The I/O controller 12 transmits an SCSI command, data, and the like to the remote adapter controller 13 according to an instruction from the disk controller 11. The remote adapter controller 13 controls the operation of the remote adapter 14 according to an instruction from the I/O controller 12 and performs login processing, command processing, and the like for the RAID unit 2.

The RAID unit 2 includes a disk controller 21, an I/O controller 22, a remote adapter controller 23, a remote adapter 24, and a disk 25. The remote adapter controller 23 controls the operation of the remote adapter 24 and performs requests of login processing, command processing, and the like issued from the host 1. The I/O controller 22 issues an operation instruction to the disk controller 21 based on an SCSI command or data received from the initiator machine. The disk controller 21 controls the operation of the disk 25 according to an instruction from the I/O controller 22. The remote adapter 14 of the host 1 and remote adapter 24 of the RAID unit 2 are connected to each other via a network.

The login processing from the host 1 to RAID unit 2 will next be described.

In the login processing, an iSCSI packet, which is Login Request PDU (Protocol Data Unit) or Login Response PDU, is exchanged between the initiate and target machines more than once.

FIG. 4 is a sequence diagram showing an example of operation of conventional login processing. This sequence diagram represents operations of the remote adapter controller 13 of the initiator machine and the remote adapter controller 23 of the target machine. Here, login processing with bidirectional authentication will be described. The initiator machine transmits Login Request PDU to the target machine, and the target machine transmits Login Response PDU to the initiator machine. After Security Negotiation and Login Operational Negotiation Stage have been executed as login processing, Full Feature Phase in which transmission of an SCSI command is allowed is started.

As Security Negotiation 1, the initiator machine starts login processing to offer choices of authentication methods (S111). Kerberos, SPKM1, SPKM2, CHAP, and the like can be offered as authentication methods. In this example, the initiator machine has offered CHAP, KRB5, and SPKM2 as choices of authentication methods. Then the target machine selects one from the choices offered and transmits a response (S112). In this example, the target machine notifies that it has selected CHAP as an authentication method.

Subsequently, as Security Negotiation 2, the initiator machine transmits notification on an encryption algorithm to the target machine (S121). In this example, the initiator machine has specified MD5 as an encryption algorithm. The target machine then transmits, to the initiator machine, an acceptance of the encryption algorithm together with an encryption key that the initiator machine uses to perform encryption (S122). In this example, the target machine notifies that MD5 is used as an encryption algorithm (CHAP_A:CHAP Algorithm) and the encryption key (CHAP_I: CHAP Identify, CHAP_C:CHAP Challenge) is “aa, bbbbbbbbbbbbbb”.

Subsequently, as Security Negotiation 3, the initiator machine encrypts a previously stored password (authentication information) for login to the target machine using the received encryption key and transmits, to the target machine, the encrypted password, an ID, and an encryption key that the target machine uses to perform encryption (S131). In this example, the encrypted password (CHAP_R: CHAP Response), ID (CHAP_N: CHAP Name), and encryption key (CHAP_I, CHAP_C) that have been transmitted are “cccccccc”, “dddddddd”, and “ee, ffffffff”, respectively. Subsequently, the target machine encrypts a previously stored password of the initiator machine and compares the encrypted password with the received password. When they correspond to each other, the target machine authenticates the initiator machine, encrypts a previously stored password for login to the initiator machine using the received encryption key and transmits the encrypted password and an ID to the initiator machine (S132). In this example, the target machine notifies that the encrypted password (CHAP_R) and ID (CHAP_N) are “gggggggg” and “hhhhhhhhh”, respectively.

Subsequently, the initiator machine encrypts a previously stored password of the target machine and compares the encrypted password with the received password. When they correspond to each other, the initiator machine authenticates the target machine and transmits login parameters to the target machine as Login Operational Negotiation Stage (S141). The login parameters are information necessary to establish a connection with the other machine and include maximum data size, monitoring time period, and the like. The target machine then permits the login based on the login parameters and transmits a response indicating the login permission to the initiator machine (S142).

When the initiator machine receives the response, the sequence of the login processing is ended. Thereafter, the initiator machine can transmit an SCSI command to the target machine as Full Feature Phase.

As described above, in the case where the initiator machine serves as a host, exchanges of Login Request PDU and Login Response PDU are repeated four times or more up to Full Feature Phase according to the login processing based on iSCSI. Another one or two exchanges may be required depending on the type of the negotiation.

A copy operation performed between remote machines in a case where both the initiator machine and target machine serve as a RAID unit will next be described.

FIG. 5 is a block diagram showing an example of a conventional connection configuration between the RAID units. In FIG. 5, the same reference numerals as those in FIG. 3 denote the same or corresponding parts as those in FIG. 3, and the descriptions thereof will be omitted here. As can be seen from comparison with FIG. 3, the host 1 is replaced by a RAID unit 2.

The copy operation between the RAID units is achieved by copy control processing performed by the initiator machine, in which the I/O controller 22 uses the remote adapter controller 23 to transmit an SCSI command. The I/O controller 22 has no concern about whether the remote adapter of the initiator machine has logged in the remote adapter of the target machine and only performs the copy control processing.

Copy control processing which does not require login processing will firstly be described. FIG. 6 is a sequence diagram showing an operation example of conventional copy control processing which does not require login processing. The I/O controller 22 of the initiator machine starts copy control processing to activate the remote adapter, sets timer's waiting time for a response corresponding to a command, and transmits a command to the remote adapter controller 23 (S211). The remote adapter controller 23 then performs command processing. That is, the remote adapter controller 23 transmits a command to the target machine (S212), receives a response corresponding to the command, analyses the response to obtain a command processing result (S213), and transmits the command processing result as a response to the I/O controller 22 (S214). When the I/O controller 22 receives the response, this sequence is ended.

In the above sequence, if the I/O controller 22 gets no response from the remote adapter controller 23 even after the timer's waiting time has elapsed (time-out) it aborts (cancel) the command.

Copy control processing, which involves login processing as a copy operation between remote machines using an iSCSI does, will next be described. FIG. 7 is a sequence diagram showing an operation example of conventional copy control processing which involves login processing. The I/O controller 22 starts copy control processing to activate the remote adapter, set timer's waiting time for a response corresponding to a command, and transmit a command to the remote adapter controller 23 (S311). The remote adapter controller 23 then starts login processing to the target machine in the same manner as the login processing shown in FIG. 4 to transmit Login Request PDU (S312) and receives Login Response PDU corresponding to the transmitted Login Request PDU (S313).

When the login processing is completed after several repetitions of steps S312-S313, the remote adapter controller 23 performs command processing. That is, the remote adapter controller 23 transmits a command to the target machine (S314), receives a response corresponding to the command, analyses the response to obtain a command processing result (S315), and transmits the command processing result as a response to the I/O controller 22 (S316). When the I/O controller 22 receives the response, this sequence is ended.

As a conventional art related to the present invention, there is known a data transfer method between an initiator and target which are connected to each other by an IEEE1394 interface (refer to, e.g., Jpn. Pat. Appln. Laid-Open Publication No. 2004-13634).

However, the I/O controller 22 is not aware of the login processing and sets the timer's waiting time irrespective thereof, so that the length of the timer's waiting time remain unchanged irrespective of whether the login processing is required or not. Therefore, if it takes a lot of time to complete the login processing, time-out error may be caused in the middle of the command processing.

### SUMMARY OF THE INVENTION

The present invention has been made to solve the above problem, and an object thereof is to provide a storage control apparatus, a storage control method, and a storage apparatus capable of reducing the time required to complete the login processing between storage apparatuses connected to each other by a network.

To solve the above problem, according to a first aspect of the present invention, there is provided a storage control apparatus that controls a storage, comprising: a remote adapter that communicates with the other storage control apparatus connected via a network; and a remote adapter controller that, when receiving an instruction that requires the storage control apparatus to serve as an initiator and the other storage control apparatus to serve as a target, controls the remote adapter to transmit information indicating an authentication method and encryption algorithm for login to the other storage control apparatus, encrypts its own authentication information provided by the authentication method using a first encryption key generated based on the encryption algorithm, the first encryption key having been received by the remote adapter from the other storage control apparatus, and controls the remote adapter to transmit, to the other storage control apparatus, the encrypted its own authentication information and a second encryption key that the other storage control apparatus uses to perform encryption based on the encryption algorithm.

In the storage control apparatus according to the present invention, when the remote adapter receives authentication information of the other storage control apparatus which has been encrypted using the second encryption key after the remote adapter controller controls the remote adapter to transmit the encrypted its own authentication information, the remote adapter controller uses the authentication information to authenticate the other storage control apparatus.

In the storage control apparatus according to the present invention, the remote adapter controller transmits parameters required to establish a connection between itself and the other storage control apparatus in addition to the encrypted its own authentication information and second encryption key.

In the storage control apparatus according to the present invention, when the remote adapter receives a response corresponding to the parameters together with the authentication information of the other storage control apparatus, the remote adapter controller controls the remote adapter to transmit an SCSI command to the other storage control apparatus.

In the storage control apparatus according to the present invention, when the remote adapter receives information indicating an authentication method and an encryption algorithm from the other storage control apparatus serving as an initiator, the remote adapter controller controls the remote adapter to transmit, to the other storage control apparatus, information representing an acceptance of the authentication method and encryption algorithm that the remote adapter has received and a first encryption key that the other storage control apparatus uses to perform encryption based on the encryption algorithm.

In the storage control apparatus according to the present invention, when the remote adapter receives authentication information of the other storage control apparatus and a second encryption key after transmitting the information representing an acceptance of the authentication method and encryption algorithm and first encryption key, the remote adapter controller uses the authentication information to authenticate the other storage control apparatus, uses the second encryption key to encrypt its own authentication information, and controls the remote adapter to transmit the encrypted its own authentication information to the other storage control apparatus.

In the storage control apparatus according to the present invention, when the remote adapter receives parameters required to establish a connection between itself and other storage control apparatus in addition to the authentication information of the other storage control apparatus and second encryption key, the remote adapter controller controls the remote adapter to transmit a response corresponding to the parameters together with the encrypted its own authentication information to the other storage control apparatus.

In the storage control apparatus according to the present invention, the authentication method includes a CHAP.

According to a second aspect of the present invention, there is provided a storage control method that controls a first storage apparatus and a second storage apparatus which are connected to each other via a network, comprising: a first request step in which, when the first storage apparatus serves as an initiator and the second storage apparatus serves as a target, the first storage apparatus transmits an authentication method and encryption algorithm for login to the second storage apparatus; and a second request step in which the first storage apparatus uses a first encryption key generated based on the encryption algorithm received from the second storage apparatus to encrypt the authentication information of the first storage apparatus provided by the authentication method and transmits, to the second storage apparatus, the encrypted authentication information of the first storage apparatus and a second encryption key that the second storage apparatus uses to perform encryption based on the encryption algorithm.

In the storage control method according to the present invention, when the first storage apparatus receives authentication information of the second storage apparatus which has been encrypted using the second encryption key after the second request step, the method further executes a login completion step in which the first storage apparatus uses the authentication information to authenticate the second storage apparatus.

In the storage control method according to the present invention, in the second request step, the first storage apparatus transmits parameters required to establish a connection between the first and second storage apparatus in addition to the encrypted authentication information of the first storage apparatus and second encryption key.

In the storage control method according to the present invention, when the first storage apparatus receives a response corresponding to the parameters together with the authentication information of the second storage apparatus in the login completion step, the first storage apparatus transmits an SCSI command to the second storage apparatus.

In the storage control method according to the present invention, when the second storage apparatus receives an authentication method and an encryption algorithm from the first storage apparatus after the first request step, the method further executes a first response step in which the second storage apparatus transmits, to the first storage apparatus, information representing an acceptance of the authentication method and encryption algorithm that the second storage apparatus has received and a first encryption key that the first storage apparatus uses to perform encryption based on the encryption algorithm.

In the storage control method according to the present invention, when the second storage apparatus receives authentication information of the first storage apparatus and a second encryption key after the second request step, the method further executes a second response step in which the second storage apparatus uses the authentication information to authenticate the first storage apparatus, uses the second encryption key to encrypt the authentication information of the second storage apparatus, and transmits the encrypted authentication information of the second storage apparatus to the first storage apparatus.

In the storage control method according to the present invention, in the second response step, when the second storage apparatus receives parameters required to establish a connection between the first and second storage apparatus in addition to the authentication information of the first storage apparatus and second encryption key, the second storage apparatus transmits, to the first storage apparatus, a response corresponding to the parameters together with the encrypted its own authentication information.

In the storage control method according to the present invention, the authentication method includes a CHAP.

According to a third aspect of the present invention, there is provided a storage apparatus that controls a storage comprising: a remote adapter that communicates with the other storage apparatus connected via a network; and a remote adapter controller that, when receiving an instruction that requires the storage apparatus to serve as an initiator and the other storage apparatus to serve as a target, controls the remote adapter to transmit information indicating an authentication method and encryption algorithm for login to the other storage apparatus, encrypts its own authentication information provided by the authentication method using a first encryption key generated based on the encryption algorithm, the first encryption key having been received by the remote adapter from the other storage apparatus, and controls the remote adapter to transmit, to the other storage apparatus, the encrypted its own authentication information and a second encryption key that the other storage apparatus uses to perform encryption based on the encryption algorithm.

In the storage apparatus according to the present invention, when the remote adapter receives authentication information of the other storage apparatus which has been encrypted using the second encryption key after the remote adapter controller controls the remote adapter to transmit the encrypted its own authentication information, the remote adapter controller uses the authentication information to authenticate the other storage apparatus.

In the storage apparatus according to the present invention, the remote adapter controller transmits parameters required to establish a connection between itself and the other storage apparatus in addition to the encrypted its own authentication information and second encryption key.

In the storage apparatus according to the present invention, when the remote adapter receives a response corresponding to the parameters together with the authentication informaton of the other storage apparatus, the remote adapter controller controls the remote adapter to transmit an SCSI command to the other storage apparatus.

According to the present invention, it is possible to reduce the time required to complete the login processing between storage apparatuses connected to each other by a network.

### BRIEF DESCRIPTION OF THE DRAWINGS

FIG. 1 is a block diagram showing an example of a connection configuration between RAID units according to the present embodiment;

FIG. 2 is a sequence diagram showing an example of operation of login processing performed between the RAID units according to the present embodiment;

FIG. 3 is a block diagram showing an example of a conventional connection configuration between a host and RAID unit;

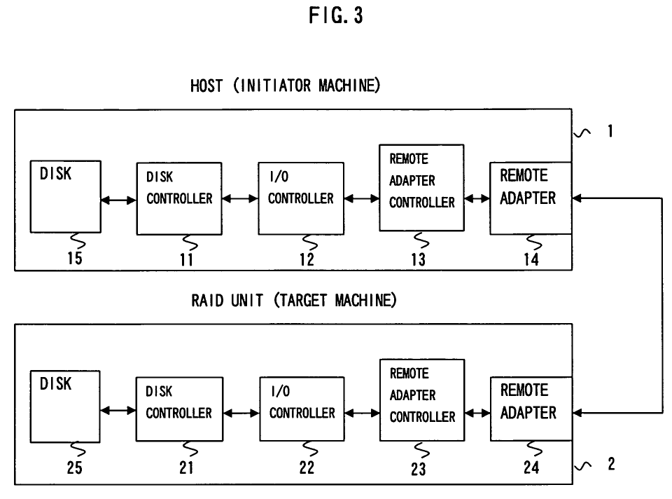

FIG. 4 is a sequence diagram showing an example of operation of conventional login processing;

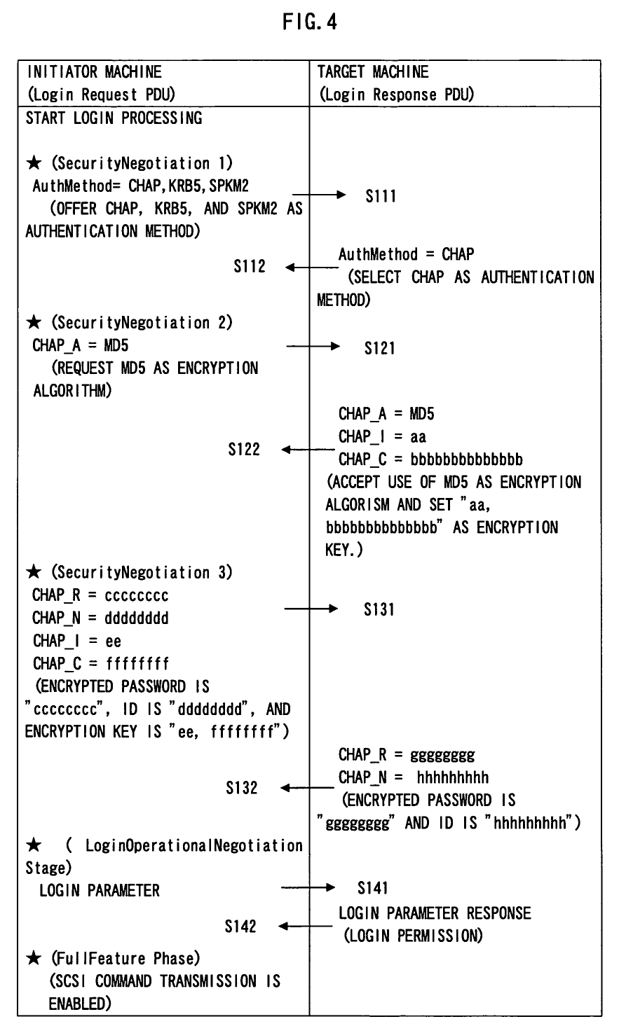

FIG. 5 is a block diagram showing an example of a conventional connection configuration between the RAID units;

FIG. 6 is a sequence diagram showing an operation example of conventional copy control processing which does not require login processing; and

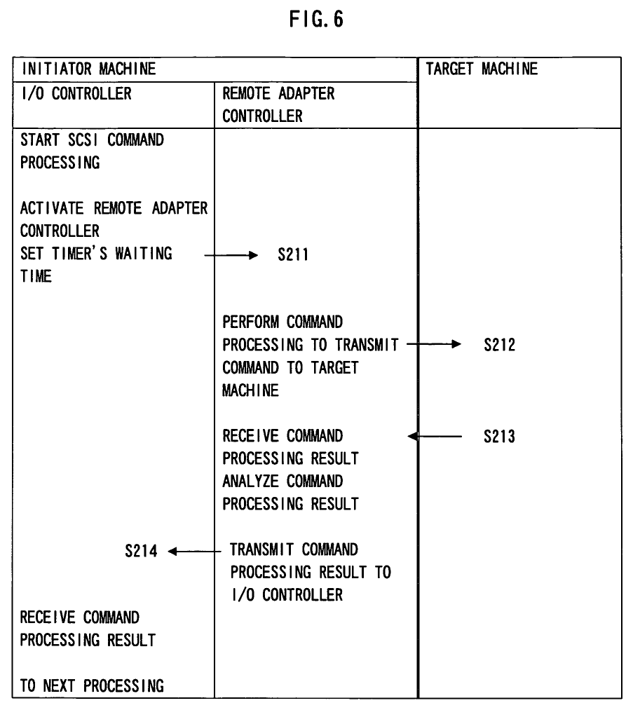

FIG. 7 is a sequence diagram showing an operation example of conventional copy control processing which involves login processing.

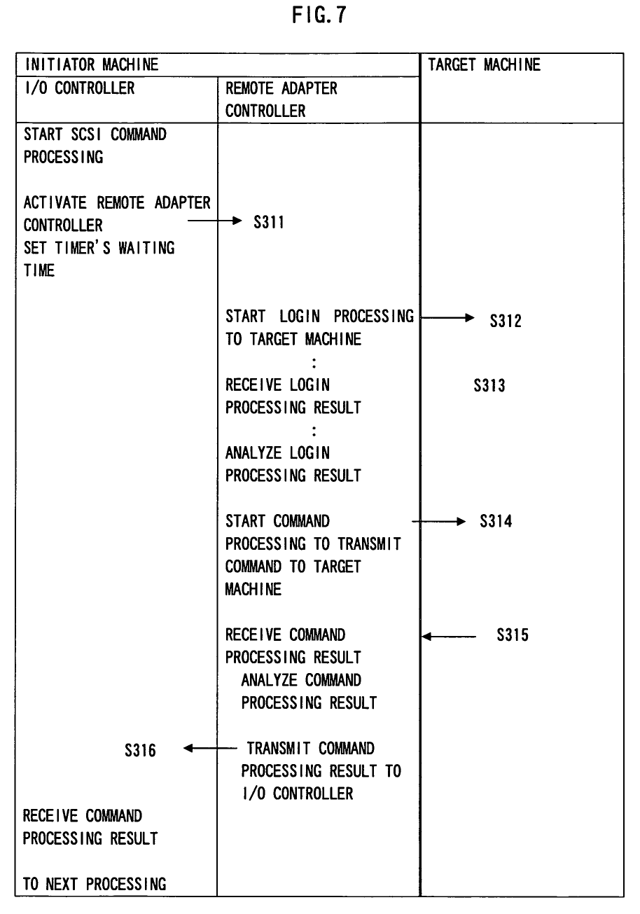

### DETAILED DESCRIPTION OF THE PREFERRED EMBODIMENTS

An embodiment of the present invention will be described below with reference to the accompanying drawings.

A configuration of a RAID unit (storage apparatus) according to the present embodiment will firstly be described.

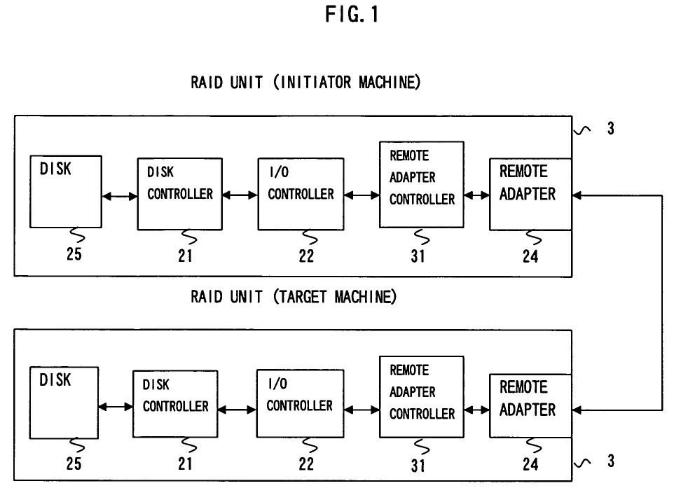

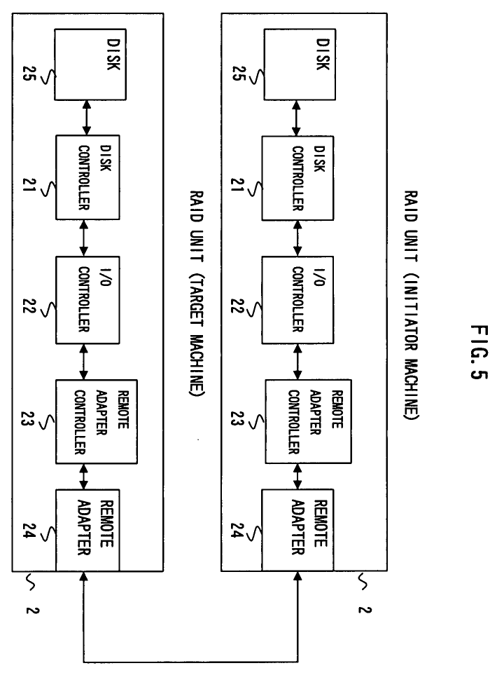

FIG. 1 is a block diagram showing an example of a connection configuration between RAID units according to the present embodiment. In FIG. 1, the same reference numerals as those in FIG. 5 denote the same or corresponding parts as those in FIG. 5, and the descriptions thereof will be omitted here. As can be seen from comparison with FIG. 5, the host 1, RAID unit 2, and remote adapter controller 23 are replaced by a RAID unit 3, RAID unit 3, and remote adapter controller 31 (storage control apparatus), respectively. The remote adapters 24 and 24 are connected to each other via a network.

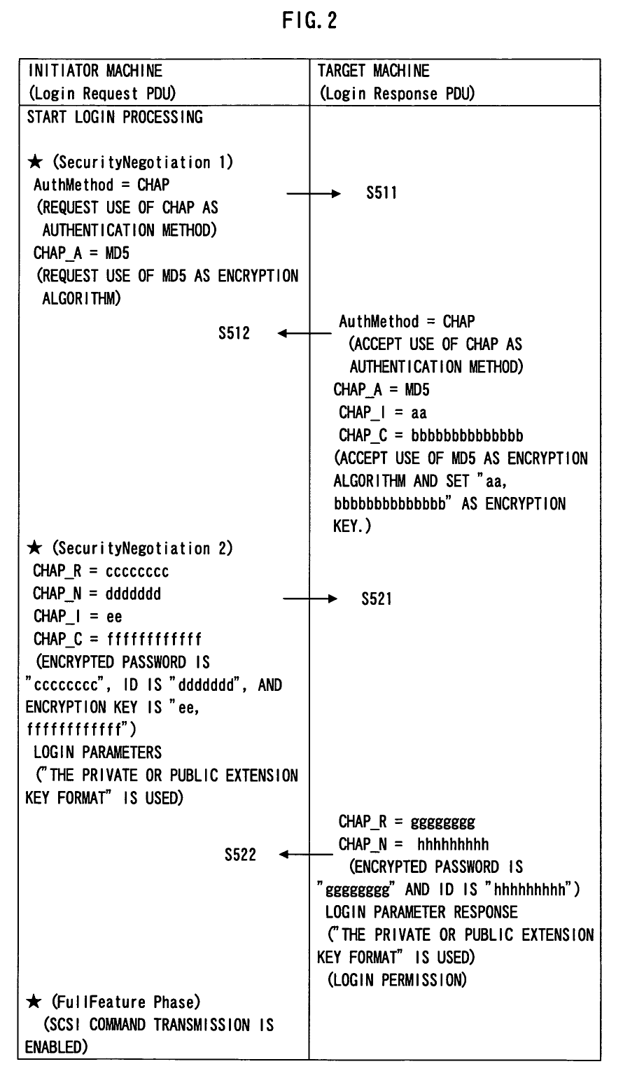

FIG. 2 is a sequence diagram showing an example of operation of login processing performed between the RAID units according to the present embodiment. This sequence diagram represents operations of the remote adapter controller 31 of the initiator machine and the remote adapter controller 31 of the target machine. As is the case with the conventional login processing, the initiator machine transmits Login Request PDU to the target machine, and the target machine transmits Login Response PDU to the initiator machine.

As Security Negotiation 1, the initiator machine starts login processing and then transmits a request of an authentication method and encryption algorithm (S511: first request step). In this example, the initiator requests a use of CHAP as an authentication method and MD5 as an encryption algorithm.

In the case where the target machine accepts the requested authentication method and encryption algorithm, it transmits, to the initiator machine, an acceptance of the specified authentication method and encryption algorithm together with an encryption key (first encryption key) that the initiator machine uses to perform encryption (S512: first response step). In this example, the target machine notifies that it has accepted the use of CHAP as an authentication method and MD5 as an encryption algorithm (CHAP_A), and that the encryption key (CHAP_I, CHAP_C) is “aa, bbbbbbbbbbbbbb”.

Subsequently, as Security Negotiation 2, the initiator machine encrypts a previously stored password for login to the target machine using the received encryption key and transmits, to the target machine, the encrypted password, an ID, and an encryption key that the target machine uses to perform encryption (second encryption key), and login parameters (S521: second request step). In this example, the encrypted password (CHAP_R), ID (CHAP_N), and encryption key (CHAP_I, CHAP_C) that have been transmitted are “cccccccc”, “ddddddd”, and “ee, ffffffffffff”, respectively. Since the login parameters cannot be transmitted over a common Security Negotiation, they are transmitted using “The Private or Public Extension Key”.

Subsequently, the target machine encrypts a previously stored password of the initiator machine and compares the encrypted password with the received password. When they correspond to each other, the target machine authenticates the initiator machine. Then the target machine encrypts a previously stored password for login to the initiator machine using the received encryption key and transmits the encrypted password and an ID, and a response corresponding to the login parameters to the initiator machine (S522: second response step). In this example, the target machine notifies that the encrypted password (CHAP_R) and ID (CHAP_I) are “gggggggg” and “hhhhhhhhh”, respectively. The response corresponding to the login parameters is transmitted using “The Private or Public Extension Key” as is the case with the login parameters.

The initiator machine receives the response and uses the received password and ID to authenticate the target machine (login completion step), and then the sequence of the login processing is ended. Afterward, the remote adapter controller 31 of the initiator machine transmits an SCSI command to the target machine as Full Feature Phase.

According to this login processing, exchanges of Login Request PDU and Login Response PDU are repeated only two times up to Full Feature Phase. Thus, processing time is significantly reduced as compared to the conventional login processing.

The storage control apparatus according to the present embodiment can easily be applied to a storage apparatus to improve the performance of the storage apparatus. Examples of the storage apparatus include a disk apparatus, a RAID unit, and the like.

What is claimed is:

1. A storage control apparatus that controls a storage comprising:
a remote adapter that communicates with the other storage control apparatus connected via a network; and
a remote adapter controller that, when receiving an instruction that requires the storage control apparatus to serve as an initiator and the other storage control apparatus to serve as a target, controls the remote adapter to transmit information indicating an authentication method and encryption algorithm for login to the other storage control apparatus, encrypts its own authentication information provided by the authentication method using a first encryption key generated based on the encryption algorithm, the first encryption key having been received by the remote adapter from the other storage control apparatus, and controls the remote adapter to transmit, to the other storage control apparatus, the encrypted its own authentication information and a second encryption key that the other storage control apparatus uses to perform encryption based on the encryption algorithm.

2. The storage control apparatus according to claim 1, wherein,
when the remote adapter receives authentication information of the other storage control apparatus which has been encrypted using the second encryption key after the remote adapter controller controls the remote adapter to transmit the encrypted its own authentication information, the remote adapter controller uses the authentication information to authenticate the other storage control apparatus.

3. The storage control apparatus according to claim 2, wherein
the remote adapter controller transmits parameters required to establish a connection between itself and the other storage control apparatus in addition to the encrypted its own authentication information and second encryption key.

4. The storage control apparatus according to claim 3, wherein,
when the remote adapter receives a response corresponding to the parameters together with the authentication information of the other storage control apparatus, the remote adapter controller controls the remote adapter to transmit an SCSI command to the other storage control apparatus.

5. The storage control apparatus according to claim 1, wherein,
when the remote adapter receives information indicating an authentication method and an encryption algorithm from the other storage control apparatus serving as an initiator, the remote adapter controller controls the remote adapter to transmit, to the other storage control apparatus, information representing an acceptance of the authentication method and encryption algorithm that the remote adapter has received and a first encryption key that the other storage control apparatus uses to perform encryption based on the encryption algorithm.

6. The storage control apparatus according to claim 5, wherein,
when the remote adapter receives authentication information of the other storage control apparatus and a second encryption key after transmitting the information representing an acceptance of the authentication method and encryption algorithm and first encryption key, the remote adapter controller uses the authentication information to authenticate the other storage control apparatus, uses the second encryption key to encrypt its own authentication information, and controls the remote adapter to transmit the encrypted its own authentication information to the other storage control apparatus.

7. The storage control apparatus according to claim 6, wherein,
when the remote adapter receives parameters required to establish a connection between itself and other storage control apparatus in addition to the authentication information of the other storage control apparatus and second encryption key, the remote adapter controller controls the remote adapter to transmit a response corresponding to the parameters together with the encrypted its own authentication information to the other storage control apparatus.

8. The storage control apparatus according to claim 1, wherein
the authentication method includes a CHAP.

9. A storage control method that controls a first storage apparatus and a second storage apparatus which are connected to each other via a network, comprising:
a first request step in which, when the first storage apparatus serves as an initiator and the second storage apparatus serves as a target, the first storage apparatus transmits an authentication method and encryption algorithm for login to the second storage apparatus; and
a second request step in which the first storage apparatus uses a first encryption key generated based on the encryption algorithm received from the second storage apparatus to encrypt the authentication information of the first storage apparatus provided by the authentication method and transmits, to the second storage apparatus, the encrypted authentication information of the first storage apparatus and a second encryption key that the second storage apparatus uses to perform encryption based on the encryption algorithm.

10. The storage control method according to claim 9, wherein,
when the first storage apparatus receives authentication information of the second storage apparatus which has been encrypted using the second encryption key after the second request step, the method further executes a login completion step in which the first storage apparatus uses the authentication information to authenticate the second storage apparatus.

11. The storage control method according to claim 10, wherein,
in the second request step, the first storage apparatus transmits parameters required to establish a connection between the first and second storage apparatus in addition to the encrypted authentication information of the first storage apparatus and second encryption key.

12. The storage control method according to claim 11, wherein,
when the first storage apparatus receives a response corresponding to the parameters together with the authentication information of the second storage apparatus in the login completion step, the first storage apparatus transmits an SCSI command to the second storage apparatus.

13. The storage control method according to claim 9, wherein,
when the second storage apparatus receives an authentication method and an encryption algorithm from the first storage apparatus after the first request step, the method further executes a first response step in which the second storage apparatus transmits, to the first storage apparatus, information representing an acceptance of the authentication method and encryption algorithm that the second storage apparatus has received and a first encryption key that the first storage apparatus uses to perform encryption based on the encryption algorithm.

14. The storage control method according to claim 13, wherein,
when the second storage apparatus receives authentication information of the first storage apparatus and a second encryption key after the second request step, the method further executes a second response step in which the second storage apparatus uses the authentication information to authenticate the first storage apparatus, uses the second encryption key to encrypt the authentication information of the second storage apparatus, and transmits the encrypted authentication information of the second storage apparatus to the first storage apparatus.

15. The storage control method according to claim 14, wherein,
in the second response step, when the second storage apparatus receives parameters required to establish a connection between the first and second storage apparatus in addition to the authentication information of the first storage apparatus and second encryption key, the second storage apparatus transmits, to the first storage apparatus, a response corresponding to the parameters together with the encrypted its own authentication information.

16. The storage control method according to claim 9, wherein,
the authentication method includes a CHAP.

17. A storage apparatus that controls a storage comprising:
a remote adapter that communicates with the other storage apparatus connected via a network; and
a remote adapter controller that, when receiving an instruction that requires the storage apparatus to serve as an initiator and the other storage apparatus to serve as a target, controls the remote adapter to transmit information indicating an authentication method and encryption algorithm for login to the other storage apparatus, encrypts its own authentication information provided by the authentication method using a first encryption key generated based on the encryption algorithm, the first encryption key having been received by the remote adapter from the other storage apparatus, and controls the remote adapter to transmit, to the other storage apparatus, the encrypted its own authentication information and a second encryption key that the other storage apparatus uses to perform encryption based on the encryption algorithm.

18. The storage apparatus according to claim 17, wherein,
when the remote adapter receives authentication information of the other storage apparatus which has been encrypted using the second encryption key after the remote adapter controller controls the remote adapter to transmit the encrypted its own authentication information, the remote adapter controller uses the authentication information to authenticate the other storage apparatus.

19. The storage apparatus according to claim 18, wherein
the remote adapter controller transmits parameters required to establish a connection between itself and the other storage apparatus in addition to the encrypted its own authentication information and second encryption key.

20. The storage control apparatus according to claim 19, wherein,
when the remote adapter receives a response corresponding to the parameters together with the authentication information of the other storage apparatus, the remote adapter controller controls the remote adapter to transmit an SCSI command to the other storage apparatus.
